(19) United States
(12) Patent Application Publication
(10) Pub. No.: US 2012/0029992 A1
(43) Pub. Date: Feb. 2, 2012

(54) SYSTEM AND METHOD FOR MAXIMIZING VALUE THROUGH COLLABORATION AND POOLING OF BUYERS, SELLERS AND PARTIES WITH COMMON INTERESTS

(76) Inventor: PASQUALE DE FACENDIS, Vaughan (CA)

(21) Appl. No.: 13/192,072

(22) Filed: Jul. 27, 2011

Related U.S. Application Data
(60) Provisional application No. 61/368,084, filed on Jul. 27, 2010.

(51) Int. Cl. G06Q 30/00

(52) U.S. Cl. 705/14.23; 705/26.2

(57) ABSTRACT

A system and method for enabling buyers and sellers to collaborate within their communities of interest and other social networks to determine similar buying interests, negotiate best pricing and terms in order to realize optimum deal terms, and close their collective best deal (for those buyers that are willing to commit once deal pricing and terms have been presented) in a real-time, dynamic manner analogous to how deals are negotiated in the real world. Further augmenting the current state-of-the-art, buyers are given the opportunity to pool their collective buying requirements from specific sellers for discounts based on volume pricing thereby enabling the purchase of potentially many goods from the sellers instead of being limited to a specific item, or group of items. Sellers are also given the opportunity to advertise and offer their goods for sale through a website, and the system can match-up buyers and sellers with common interests and enable both parties to discuss, negotiate and close their best deal, thereby resulting in a true win-win transaction since both buyer-specific and user interests are explored and satisfied. The invention also enables a portion of deal revenues to be donated to a common cause or charity thereby further motivating users with common interests to pool together, maximize deal volume and value, and drive traffic to the internet-enabled system, with the potential for significantly improving the human condition on a global scale.

### FIELD OF THE INVENTION

This invention relates to a system and method for enabling identification, collaboration and pooling of buyers and sellers over the internet and/or communication networks.

### BACKGROUND OF THE INVENTION

Over the past two decades, the internet has proven to be a powerful medium for efficiently enabling collaboration between users for many different purposes, on a global scale. In the field of e-commerce, there are many successful examples of buyer/seller applications in the consumer-to-business and consumer-to-consumer space such as www.amazon.com, www.ebay.com, www.craigslist.com, www.redflagdeals.com and a plethora of websites to support traditional bricks and mortar businesses (for example www.bestbuy.com, www.sears.com, etc.)

While there are many business-to-business and business-to-consumer applications to enable e-commerce transactions, individuals and businesses need a simple and effective method to pool buyers with similar interests and thereby further leverage their collective buying power via a buyer-driven, truly collaborative and flexible system. In essence, to change the current paradigm from a business-to-consumer model to a consumer-to-business driven environment.

U.S. Pat. No. 7,225,154 to Hansen teaches a method and system for processing a financial transaction for a pool of buyers. A set of conditions is received that define circumstances for execution of the financial transaction, and funds are collected for each of a plurality of partial payments prior to satisfaction of the set of conditions. The collected funds are accumulated for support of the financial transaction until satisfaction or failure of the set of conditions. Hansen does not teach a method and system for allowing buyers and sellers the ability to explore collaborative purchase interests prior to defining circumstances for execution of the financial transaction and the flexibility to fully accept deal terms prior to any payment.

U.S. Pat. No. 6,260,024 to Shkedy teaches a system and method for aggregating individual buyer purchase requirements into a single collective purchase requirement, and locate sellers willing to bid on the collective purchase requirement. Shkedy makes a key element in achieving success the ability to bind the individual buyer to the pool before the purchase is made, and mandates if buyers could participate in the pool and only decide whether they wish to purchase the goods once they have been given a price, it becomes impossible to guarantee the price since the volume changes depending on the number of buyers remaining in the pool. Shkedy does not teach a method and system to support the dynamic ability of buyers to freely collaborate and strike optimum deal terms prior to making any purchase commitments.

U.S. Pat. No. 7,363,256 to Thiam teaches a method for selling consumer goods on the Internet whereby a website is established to advertise goods for sale and allowing buyers to pool together to purchase goods at one of the established price points. If not enough buyers agree to purchase goods at a published price point, then all buyers are pooled together and a sale is consummated at the lowest price point for which the pre-determined number of buyers is reached. This however is too rigid a system to be practical since buyers are expected to commit to purchases prior to getting confirmation of the actual deal price point. It also teaches a traditional seller-driven model through advertising of goods on the website and does not empower buyers to pool together to drive their own specific deal requirements.

More recently, websites such as www.groupon.com, www.teambuy.ca, www.teamsave.com and others, have established themselves to offer a discounted ‘deal of the day’ whereby a product or service is advertised and offered on the website at a discounted price to a pool of buyers that are interested in signing up for the deal. U.S. Pat. No. 6,269,343 to Pallakoff teaches a method and system that allows sellers to communicate conditional offers to potential buyers, thereby allowing such sellers to offer volume-based pricing discounts. Further, U.S. Pat. No. 7,672,897 to Chung et al teaches a method for offering a fixed discount price to collect and attempt to consummate a number of buys by a cutoff date. However, these approaches are too static and their shortcomings are significant given that for example, only one or relatively few deals are offered on a daily basis to many segments of buyers with different purchase interests and requirements, potential buyers are not given the opportunity to pool with their friends and communities of interest to drive deals that are important to their specific purchasing requirements, and that the current approach is very much a seller driven vs buyer driven model. Further, buyers are only provided the opportunity to bid on one specific item from a given seller. What is not taught in the prior art is a method and system to enable a pool of buyers with similar interests to freely collaborate amongst themselves and with potential sellers to freely and dynamically explore and establish optimum deal terms prior to purchase commitments from any buyers.

Furthermore, the internet has also become a valuable catalyst in promoting awareness of, and enabling action in support of many humanitarian causes. Some example are: www.one.org, www.afa.net. For the most part, legacy charitable organizations have simply defaulted to setting-up a website with supporting information about the organization, causes, etc. and allowing users the option of donating on-line through a secure payment method. Other websites like www.thehungersite.com, allow users to click on a wide mix of banner advertisements whereby individual advertisers then pay thehungersite.com a fixed amount on a per click basis in support of various charitable causes. Thehungersite.com retains a portion of the ad revenue for operational purposes and profit, and uses remaining revenues to support its charity partners. There are a number of challenges with thehungersite's approach including: no effective targeting of ads to users of interest, small incremental revenue on a per click-through basis, and most importantly vulnerability and weakness of the system to enable users to simply visit the website regularly and click on ads to support charities with little real awareness or interest in banner ad sponsors and what they have to offer.

What is needed is an internet-enabled system that provides buyers and sellers with a valuable means to identify common interests, enable buyers with similar buying interests to pool together in order to maximize discount potential through various sellers, close their best deal and enable a significant portion of the sale (compared to value of traditional banner Ad revenue) to be donated to a common cause or charity. In effect, to change the current commerce model from a seller-driven to a buyer-driven system. The common cause or charity contribution aspect can be a powerful motivator for users with common interests to pool together and drive traffic to the internet-enabled system, with the potential for significantly improving the human condition on a global scale.

### SUMMARY OF THE INVENTION

This invention presents a system and method for allowing potential buyers and sellers with common interests to express their needs for specific product and/or service purchases, and/or support of like-minded causes via a collaborative, social networking based model through which parties with similar interests identify and pool together with other parties having related interests, collaborate and approach sellers for quotations, negotiate and confirm deals, and take deliveries. Collaboration between buyers and sellers can be enabled through the internet and can relate to pre-planned or spontaneous purchases, and make use of wireline or wireless terminals for interaction and communication via text, voice and/or multimedia. Global Positioning Satellite (GPS), Wi-Fi and/or other location-based capabilities can also be used to allow buyers and sellers to locate themselves and enable face-to-face meetings in a dynamic manner.

In one aspect, the present invention is a system and method for allowing a user with a particular buying interest to go to a website, set-up an account, identify their particular buying interest and purchase transaction timeframe. The website allows for other users with similar buying interests (defined as users not necessarily looking to buy the exact same items but rather items from the same seller) to also set-up an account, search the website for established buyer pools with the same buying interests (and in same geographic location if necessary), join such buyer pool and participate in the purchase transaction. If a user does not find a suitable buyer pool or wishes to set-up their own buyer pool, the website allows for this as well, in addition to identification and consolidation of buyer pools with similar interests.

In one aspect of the invention, a computer network implemented sales method for organizing and completing a dynamic pooled transaction is provided, where the method involves at least two buyers and at least one seller, wherein the at least two buyers and at least one seller are each associated with a network-connected communication device, such method comprising the following steps:
enabling a group of buyers including at least two buyers, by operation of a server computer that implements a distribution platform for organizing and completing a dynamic pooled transaction, wherein the server computer communicates with the network-connected communication devices via a wired or wireless communication network, to explore dynamically similar purchase criteria for establishing a buying pool, for approaching at least one seller with a solicitation for the purchase of goods or services;
enabling the group of buyers to invite their contacts to join the buying pool, and communicating one or more data elements associated with the buying pool to other interested buyers associated with the server computer and enabling such other buyers interested in joining the buyer pool to join such buyer pool;
if similar purchase criteria for such buyer pool are satisfied within the required time constraint, enabling the buyer members to connect with the at least one seller to negotiate a quotation for pooled goods or services requirements of such buyer pool; if one or more other sellers is also available to provide a quotation, enabling such buyer pool members to further connect with such one or more other sellers until quotations from all sellers have been obtained and/or buyer pool closes one or more transactions based on the goods or services;
enabling the group of buyers, and optionally one or more sellers by operation of the server computer to submit rating and comments;
enabling the group of buyers to establish consensus by operation of the server computer around a quotation of a particular seller, or winning seller; and
if a consensus is established within the group of buyers, enabling the group of buyers having reached such consensus to close the one or more transactions based on the goods or services with the winning seller.

In a further aspect of the invention, if a new buyer is interested in participating in the one or more transactions, enabling such new buyer to approach the winning seller to negotiate and close best deal; such seller pays commission to distribution platform and referring buyer; when commissions received, buyers, seller and distribution platform submit rating and comments, otherwise re-submit commissions request to seller until such time that commissions request is exhausted at which time buyers, seller and distribution platform submit rating and comments.

In another aspect of the invention, a computer network implemented system is provided for organizing and completing a dynamic pooled transaction, the system comprising:
one or more server computers, operable to connected to one or more network-connected communication devices via a wired or wireless communication network, the one or more network-connected devices being associated with at least two buyers and at least one seller,
the one or more server computers including or being linked to a web application that implements a distribution platform that enables:
(A) a group of buyers including at least two buyers to explore dynamically similar purchase criteria for establishing a buying pool, for approaching at least one seller with a solicitation for the purchase of goods or services;
(B) the group of buyers to invite their contacts to join the buying pool, and communicate one or more data elements associated with the buying pool to other interested buyers associated with the server computer and such other buyers interested in joining the buyer pool to join such buyer pool;
(C) if similar purchase criteria for such buyer pool are satisfied within the required time constraint, the buyer members to connect with the at least one seller to negotiate a quotation for pooled goods or services requirements of such buyer pool; if one or more other sellers is also available to provide a quotation, such buyer pool members to further connect with such one or more other sellers until quotations from all sellers have been obtained and/or buyer pool closes one or more transactions based on the goods or services;
(D) the group of buyers, and optionally one or more sellers by operation of the server computer to submit rating and comments;
(E) the group of buyers to establish consensus by operation of the distribution platform around a quotation of a particular seller, or winning seller; and
(F) if a consensus is established within the group of buyers, the group of buyers having reached such consensus to close the one or more transactions based on the goods or services with the winning seller.

In this respect, prior to explaining specific embodiments of the invention in detail, it is to be understood that the invention is not limited in its application to the details of construction and to the arrangements of the components set forth in the following description or outlined in the drawings. The invention is capable of other embodiments and of being practiced and implemented in various ways. Also, it is to be understood that the terminology and phraseology used herein are for the purpose of description and should not be regarded as limiting in any manner.

### BRIEF DESCRIPTION OF THE DRAWINGS

The invention is better understood and realized through consideration of the following detailed description thereof, with reference to the annexed drawings wherein:

FIG. 1 is a graphical representation of the network elements and communication system.

FIGS. 2 a) and b) are flow diagrams illustrating a method for enabling buyers with similar buying interests to pool themselves and approach sellers for volume discounts and favourable terms.

FIGS. 3 a) b) c) and d) are flow diagrams illustrating a method for allowing buyer pool(s) and seller(s) to efficiently identify purchase requirements, provide quotations and implement deal closure through a dynamic, real-time mechanism analogous to doing deals in person.

FIGS. 4 is a simplified screen diagram of a graphical user interface illustrating how a dynamic, real-time mechanism for a pooled financial transaction can be implemented through a website.

FIGS. 5 a) and b) are flow diagrams illustrating a mobile, location-based method that allows buyer and seller networks to dynamically identify themselves based on similar interests and establish communication in order to explore, negotiate and close deals.

In the above drawings, particular embodiments of the invention are illustrated by way of example. It is to be specifically understood that the drawings and description are only for illustration purposes and as an aid to understanding, and are expressly not intended to define the limits of the invention in any manner whatsoever.

### DETAILED DESCRIPTION

Embodiments of the invention provide systems and methods for effectively enabling buyers and sellers to collaborate within their communities and other social networks to determine similar buying interests, negotiate best pricing and terms, and close their collective best deal in a real-time dynamic manner as preferred by human beings through use of a dynamic pooled financial transaction.

Per the current prior art, those skilled in the art have primarily focused on designing and implementing rigid, mechanized quotation systems and processes to allow pools of buyers to initiate and complete financial transactions with sellers, thereby resulting in minimal uptake and buy-in for such financial transactions by both buyers and sellers. Examples of such rigid financial transaction models include collecting partial payments that bind buyers before full acceptance of overall deal terms and/or price points, and binding individual buyers to the buyer pool before a financial transaction is made.

Alternatively, this invention introduces the concept of a dynamic pooled financial transaction whereby: buyers and sellers are given the opportunity to dynamically explore interests and deal terms prior to any commitments being made. Further, once the appropriate level of interest is obtained from the right buyers and sellers, the invention allows all parties involved to fully explore and negotiate deal terms before a binding transaction occurs. As described below, various embodiments of the invention are possible whereby the dynamic pooled financial transaction can be fully negotiated by persons in a real-world or virtual communication environment and/or with the assistance of the system and process embodiment to facilitate negotiation and closure of the deal. Processing of payments for the completed financial transaction is also dynamic and flexible in allowing individual buyers to make payments to the seller of choice individually without the need for central administration and overhead in arranging and making payments on behalf of all buyers through one collective financial transaction. In addition, the invention allows the flexibility to allow additional buyers to join the buyer pool even after the initial deal has closed, thereby further increasing system flexibility, user satisfaction and value to both buyers and sellers through use of a dynamic pooled financial transaction.

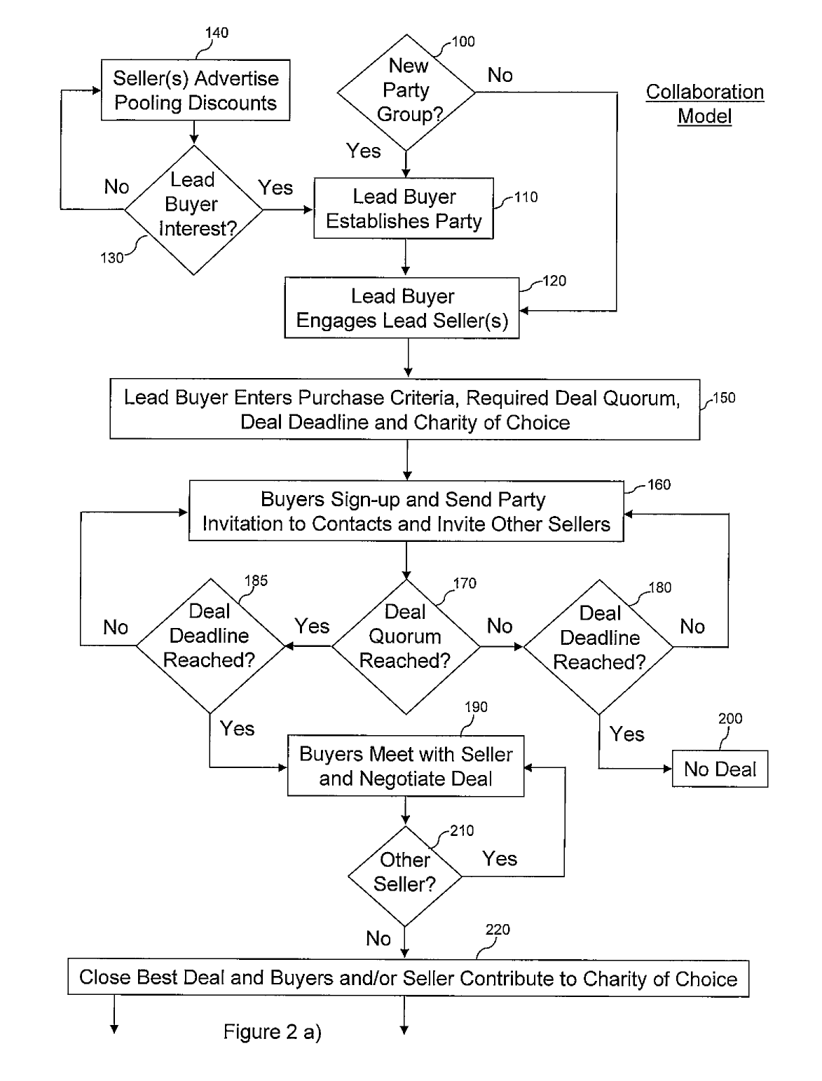

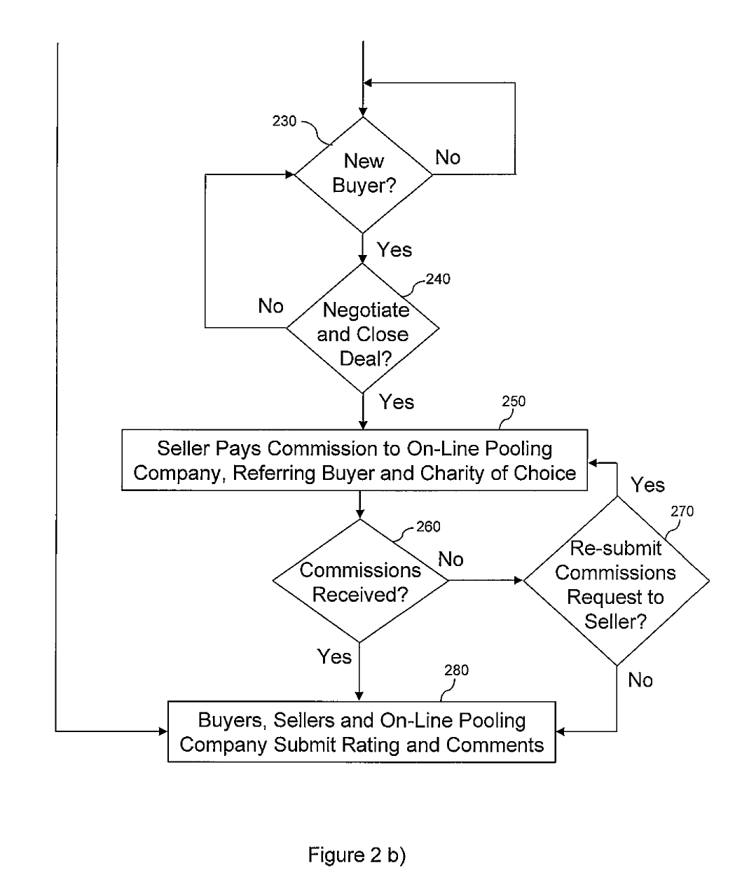

Three models are presented outlining the preferred embodiments for systems and methods for effectively enabling buyers and sellers to collaborate, negotiate and close best pricing and terms through use of the dynamic pooled financial transaction concept. The details and operation of such preferred embodiments are illustrated in FIGS. 2 to 5.

In one aspect of the invention, a computer network implemented sales method for organizing and completing a dynamic pooled transaction is provided, where the method involves at least two buyers and at least one seller, wherein the at least two buyers and at least one seller are each associated with a network-connected communication device, such method comprising the following steps:
enabling a group of buyers including at least two buyers, by operation of a server computer that implements a distribution platform for organizing and completing a dynamic pooled transaction, wherein the server computer communicates with the network-connected communication devices via a wired or wireless communication network, to explore dynamically similar purchase criteria for establishing a buying pool, for approaching at least one seller with a solicitation for the purchase of goods or services;
enabling the group of buyers to invite their contacts to join the buying pool, and communicating one or more data elements associated with the buying pool to other interested buyers associated with the server computer and enabling such other buyers interested in joining the buyer pool to join such buyer pool;
if similar purchase criteria for such buyer pool are satisfied within the required time constraint, enabling the buyer members to connect with the at least one seller to negotiate a quotation for pooled goods or services requirements of such buyer pool; if one or more other sellers is also available to provide a quotation, enabling such buyer pool members to further connect with such one or more other sellers until quotations from all sellers have been obtained and/or buyer pool closes one or more transactions based on the goods or services;
enabling the group of buyers, and optionally one or more sellers by operation of the server computer to submit rating and comments;
enabling the group of buyers to establish consensus by operation of the server computer around a quotation of a particular seller, or winning seller; and
if a consensus is established within the group of buyers, enabling the group of buyers having reached such consensus to close the one or more transactions based on the goods or services with the winning seller.

In another aspect of the invention, a computer network implemented system is provided for organizing and completing a dynamic pooled transaction, the system comprising:
one or more server computers, operable to connected to one or more network-connected communication devices via a wired or wireless communication network, the one or more network-connected devices being associated with at least two buyers and at least one seller,
the one or more server computers including or being linked to a web application that implements a distribution platform that enables:
(A) a group of buyers including at least two buyers to explore dynamically similar purchase criteria for establishing a buying pool, for approaching at least one seller with a solicitation for the purchase of goods or services;
(B) the group of buyers to invite their contacts to join the buying pool, and communicate one or more data elements associated with the buying pool to other interested buyers associated with the server computer and such other buyers interested in joining the buyer pool to join such buyer pool;
(C) if similar purchase criteria for such buyer pool are satisfied within the required time constraint, the buyer members to connect with the at least one seller to negotiate a quotation for pooled goods or services requirements of such buyer pool; if one or more other sellers is also available to provide a quotation, such buyer pool members to further connect with such one or more other sellers until quotations from all sellers have been obtained and/or buyer pool closes one or more transactions based on the goods or services;
(D) the group of buyers, and optionally one or more sellers by operation of the server computer to submit rating and comments;
(E) the group of buyers to establish consensus by operation of the distribution platform around a quotation of a particular seller, or winning seller; and
(F) if a consensus is established within the group of buyers, the group of buyers having reached such consensus to close the one or more transactions based on the goods or services with the winning seller.

Sellers are also given the opportunity to advertise their goods and services for sale using a targeted method to specific buyer requirements, with appropriate commissions paid to such website in consideration for advertising and deal facilitation, as required.

Three aspects of the invention are presented, the first being a collaborative method that enables buyers with similar buying interests to pool themselves and approach sellers for volume discounts and favourable terms, the second being an automated web-based method to allow buyer pool(s) and seller(s) to efficiently identify purchase requirements, provide quotations and implement deal closure through a dynamic, real-time mechanism analogous to doing deals in person using a real-world simulation model, and third a mobile, location-based method that allows buyer and seller networks to dynamically identify themselves based on similar interests and requirements, and establish communication in order to collaboratively explore, negotiate and close deals with sellers.

The ability for donating a portion of deal savings to a common cause or charity of interest is also provided, whereby such option can also be used as a motivating mechanism for driving additional buyers to the website and buyer pool. Further, the invention allows for additional buyers to participate after initial deal close either spontaneously or through a referral/commission mechanism upon acceptance of respective deal terms by the parties involved. Also, once buyer pools become large enough through organic growth and/or integration with other buyer pools, the opportunity for buying direct from manufacturers and OEMs is also enabled by the invention, with the potential to disrupt established bricks-and-mortar and online vendor business models. When volumes become large enough, a franchising model and method for white labeling bricks-and-mortar pooling depots can also be established to facilitate large volume deliveries for buyers from manufacturers and OEMs who are not willing to make individual deliveries to each buyer. The pooling depot would take a commission for its role and value-add in facilitating deliveries.

Architecture

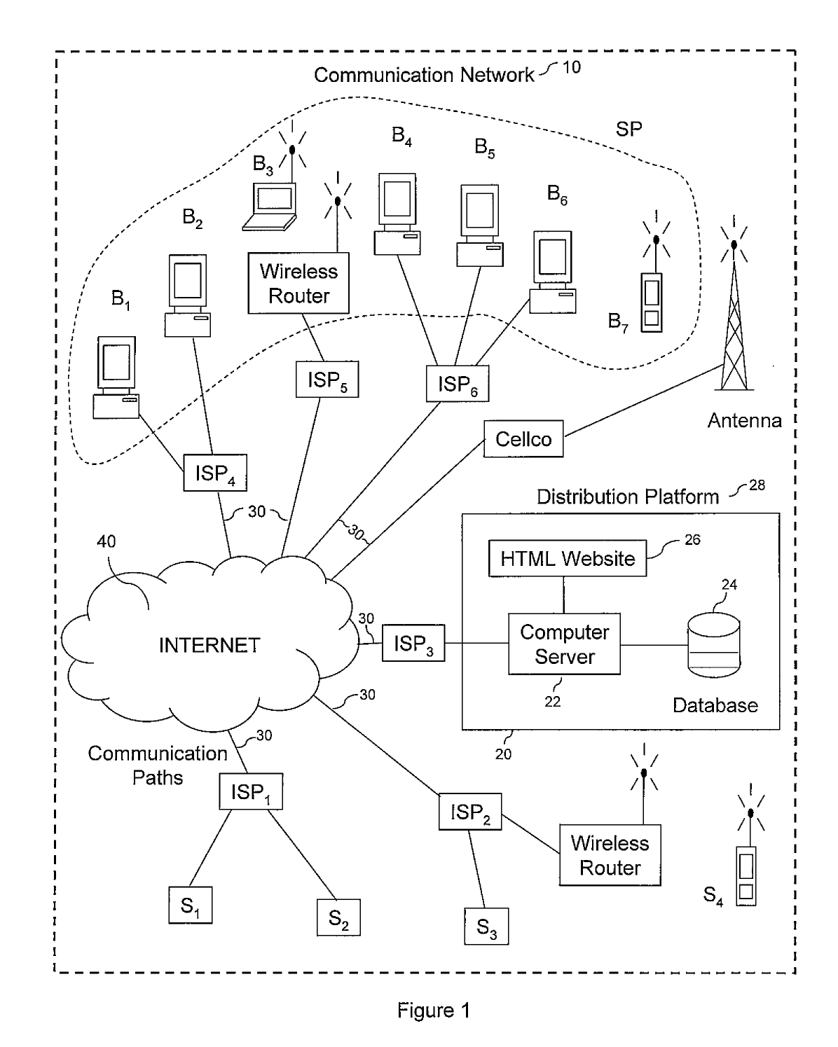

FIG. 1 provides an illustration of one possible architecture that may be used to enable such embodiments for the dynamic pooling of buyers in order to facilitate optimum deal terms from sellers. Referring to FIG. 1, a communication system (10) includes a computer server (22) that implements the distribution platform (28). It should be understood that the computer server (22) may be implemented using one or more server computers, or a server farm, or any distributed computer architecture including for example a distributed computer architecture including cloud computing resources. Computer server (22) is connected to a database (24) and is managed by database management software by such computer server (22). In this embodiment, computer server (22) is a world wide web server machine networked to the internet via internet service provider ISP₃ via communication paths (30) and using industry standard client devices and protocols. Distribution platform (28) is best understood as a web application that is operable to present a series of web pages that together providing website (26) (which may be implemented for example as an HTML website) that allows remote sellers S₁, S₂, S₃ and S₄, and buyers B₁, B₂, B₃, B₄, B₅, B₆ and B₇ to collaborate and do deals as further explained below.

It should be understood that computer server (22) and also the distribution platform (28) may incorporate or be linked to a social media engine that enables for example the buyers to leverage their social networks to attract other buyers to the dynamic buyer pools enabled by the present invention. For example, the distribution platform (28) may link to a social media platform such as FACEBOOK™ (for example using APIs made available by FACEBOOK for this purpose) in a manner that is known so as to dynamically invite social media connections of a particular buyer, including for example based on filtration of such social media connections based on likelihood of interest, whether such filtration is enabled by FACEBOOK or in fact by means of one or more mechanisms implemented to the distribution platform (28). It should be understood that the filtration of such social media connections or other contacts may occur based on the location of the seller, a cluster of buyers at the time that are part of the buyer pool, the nature of the products or services, interest in the brand of the seller, and so on. The present invention enables the dynamic assembly of buyer pools that share interest in the goods and services, and further enable the buyer pool that is formed to achieve consensus around proposed terms and conditions so as to arrive at a transaction that is acceptable to the buyers participating in the pool, or a subset thereof, as the evolution of the terms and conditions may cause some buyers to lose interest. The present invention enable the creation of this consensus using a system architecture and series of associated workflow in a highly efficient manner. The invention, with an investment of a reasonable amount of time involved in participating in the workflows described, to achieve significant improvements in the terms and conditions available from a seller, as compared to the terms and conditions that any particular buyer would likely have been able to achieve on his/her own.

For this embodiment and in a similar manner using industry standard client devices and protocols with connectivity established through the internet, sellers S₁, S₂, S₃ and S₄ are connected to the internet via their respective Internet Service Providers (ISPs) ISP₁ and ISP₂. As indicated in FIG. 1, these connections can be established through either landline links or wireless connectivity, as would be appreciated and understood by those skilled in the art. As indicated in FIG. 1, Buyers B₁, B₂, B₃, B₄, B₅, B₆ and B₇ are also connected to the internet via their respective ISPs ISP₄, ISP₅, ISP₆ and Cellco₁ through both landline and wireless connectivity using industry standard client devices and protocols based on the method preferred by each individual Buyer, or any other possible client devices and/or protocols, including future devices and/or protocols not yet developed prior to the filing date of this document.

Collaboration Model

Unlike the established prior art which ties buyers and sellers to rigid and more involved process-based methods for establishing and implementing buyer pools, the Collaboration Model method has the advantage of giving buyers the ability to pool themselves together and collaborate with sellers in a straightforward and dynamic manner whereby the a website (26) (for example an HTML website) that is supported by the distribution platform (28) of the present invention. The distribution platform (28) is operable to enabled connections and collaboration, while at the same time allowing buyers and sellers the freedom and flexibility to negotiate and implement deal terms per their specific requirements without being tied to any static, previously established process via the website and/or other means. Further aspects of the distribution platform (28) are described below. For example, this collaboration model method enabled by the distribution platform (28) of the present invention may be effectively used by a group of neighbours who are interested in getting volume discounts for home services such as landscaping, painting or roofing. Given the customized nature of obtaining quotations, negotiating and completing financial transactions for such services, the dynamic pooled financial transaction concept is effectively used in such scenarios to allow interested buyers and sellers (i.e. service providers) to explore similar interests and connect with each other on a face-to-face basis in order to obtain quotations, explore volume discounts based on buyer pool requirements and complete financial transactions on a one-to-one basis between such buyers and seller(s), in the most effective manner possible. It is clear that the prior art has failed to recognize the resulting value in implementing such a dynamic system and method, therefore proving such system and method is non-obvious to those skilled in the art.

FIGS. 2 a) and b) are flow diagrams illustrating the overall flow of a collaborative method that enables buyers with similar buying interests to pool themselves and approach sellers for volume discounts and favourable terms. To start the process, a new buyer visits html website (26) of distribution platform (28) and in step (100) decides whether to establish a new party group or review existing party groups with similar buying interests and join such preferred party group, if one exists. Should buyer decide to establish a new party group, such buyer establishes themselves as lead buyer and establishes new party group per step (110) and contacts lead seller(s) to establish interest in negotiating a volume-based deal for interested pool of buyers with similar buying interests per step (120). Otherwise if buyer decides to join existing party group with similar buying interests, buyer joins such group whereby existing lead buyer would engage lead seller(s) per step (120). Alternatively, per step (140), seller(s) are given the opportunity to advertise pooling based discounts for their goods and services on html website (26) of distribution platform (28). Potential buyers visit such html website and if interested in engaging with seller per step (130), such lead buyer establishes party group per step (110) and contacts lead seller(s) to establish interest in negotiating a volume-based deal for interested pool of buyers with similar buying interests per step (120).

Next, per step (150), lead buyer enters purchase criteria, required deal quorum, deal deadline and charity of choice on html website (26) of distribution platform (28). Note deal quorum criteria is flexible and can consist of metrics such as number of buyers, total collective deal volume in terms of number of units needing to be purchased, net sales price, etc. Per step (160), buyers sign-up and send party invitation to their network of contacts via communication mechanism of such html website (26) and/or making use of other social media communication mechanisms such as facebook, twitter, rss feeds, etc. Other interested buyers proceed to sign-up to such party group and in a similar manner invite other possible interested buyers and sellers through their network of contacts per step (160). If the required deal quorum is not reached per step (170) and the deal deadline is also not reached per step (180), buyers in the party group are still given the opportunity to invite possible interested buyers and sellers through their network of contacts per step (160). If the deal quorum is not reached per step (170) and the deal deadline is reached per step (180), then the deal does not proceed per step (200). Per step (170), if the deal quorum is reached but the deal deadline is not reached per step (185), buyers in the party group are again given the opportunity to invite possible interested buyers and sellers through their network of contacts per step (160). However, if the deal quorum is reached per step (170) and the deal deadline is reached per step (185), buyers arrange to meet with seller in person or remotely per their preferred communication mechanism at a mutually convenient time to review their requirements and negotiate their best deal per step (190). With this collaboration model, the html website (26) of distribution platform (28) enables communication of buyers and sellers through exchange of their contact information via their preferred communication mechanism(s) including but not limited to a meeting location at geographic address, conference calling using traditional telephony, VoIP, e-mail, text messaging, social networking media and/or other means. Upon completion of negotiation of best deal terms per step (190), if the party group has established a relationship with another seller per step (210), then buyers of such party group again arrange to meet with seller in person or remotely per their preferred communication mechanism at a mutually convenient time to review their requirements and negotiate their best deal per step (190). Upon completion of negotiation of best deal terms per step (190), buyers in the party group close their best deal with preferred seller and buyers and/or seller contribute a portion of the savings earned to their charity of choice per step (220). Using this Collaboration Model method, all payment transactions are carried out between buyers and seller on a person-to-person basis using manual methods or on-line payment mechanisms such as www.paypal.com.

Continuing with FIG. 2 b), buyers, seller and distribution platform (28) are given the opportunity to rate the deal and other participants, and provide comments per step (280). Per step (230) after deal close, should a new buyer wish to join the party group to take advantage of discounts offered by the preferred seller with which party group completed the deal in step (220), such new buyer is allowed to join and contact seller to negotiate and close new deal per step (240). Should deal not close, new buyers are still given the opportunity to join the party group in future per step (230). However, if the new buyer successfully closes a new deal with the seller per step (240), seller pays a commission to the distribution platform (28), referring buyer and charity of choice per previously negotiated terms per step (250). Per step (260) if seller does not pay the required commissions, the html website (26) of distribution platform (28) re-submits commissions request to seller per step (270). Otherwise if commissions are received per step (260) or after sufficient attempts to re-submit commissions request to seller per step (270), buyers, seller and distribution platform (28) are given the opportunity to rate the deal and other participants, and provide comments per step (280).

On-Line Negotiation Model

Where buyers and sellers prefer the efficiency and convenience of having the html website (26) of distribution platform (28) enable the negotiation and processing of deal payments in addition to establishing the introductions and initial collaboration, the on-line negotiation model provides a flexible and dynamic method for this purpose, unlike the prior art which employ rigid and more involved process-based methods. For example, if a group of friends were interested in purchasing new appliances or automobiles, such commodities do not require a high degree of customization (compared to the nature of home services for example), so as a result, the invention effectively uses the dynamic pooled financial transaction concept to allow interested buyers and sellers to explore similar interests, and then using the system and method to facilitate on-line specification and quotations for such potential purchases, and complete financial transactions once deal terms have been fully explored and negotiated. Such approach is non-obvious to those skilled in the art since the invention allows for dynamic use and adjustment of multiple deal variables to improve flexibility and probability of deal closure beyond that of the established prior art which basically implements a more rigid and inflexible approach for buyer acceptance.

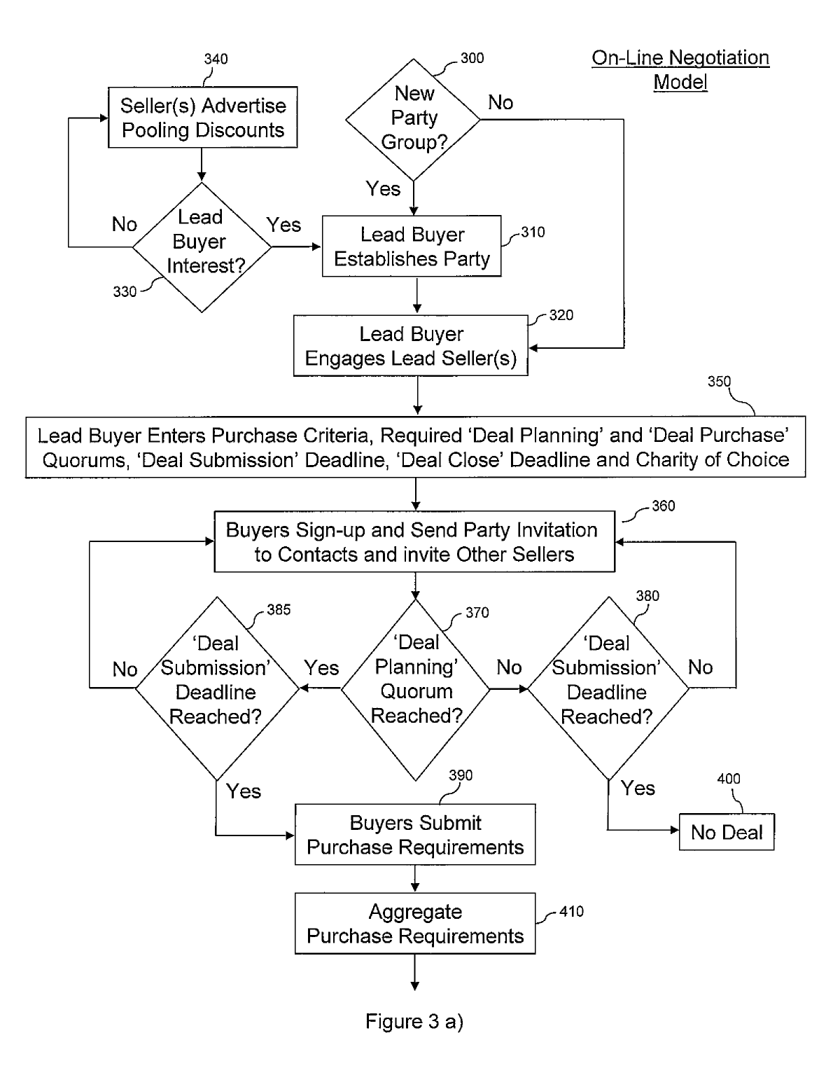

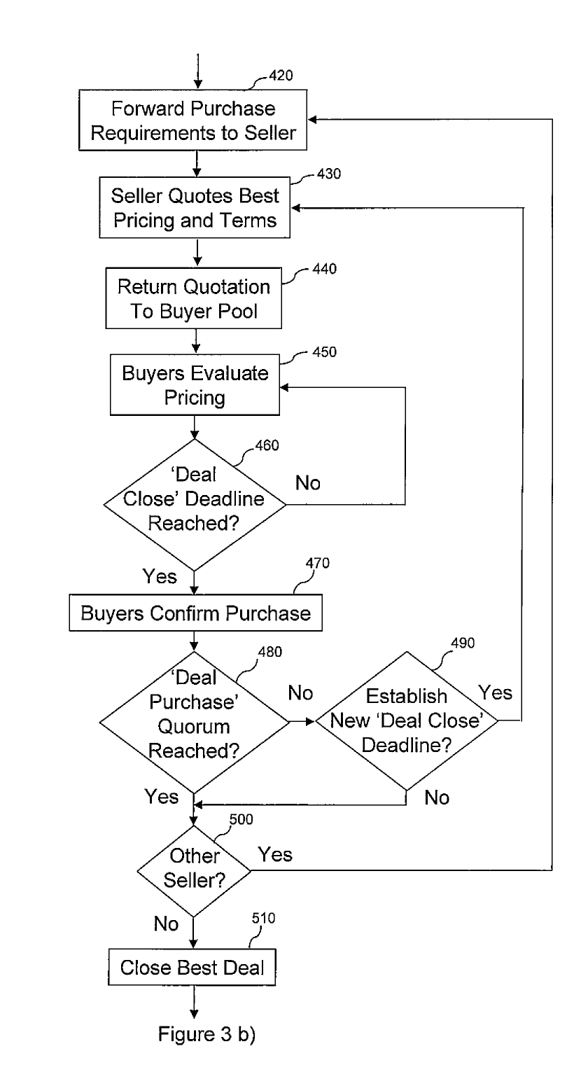

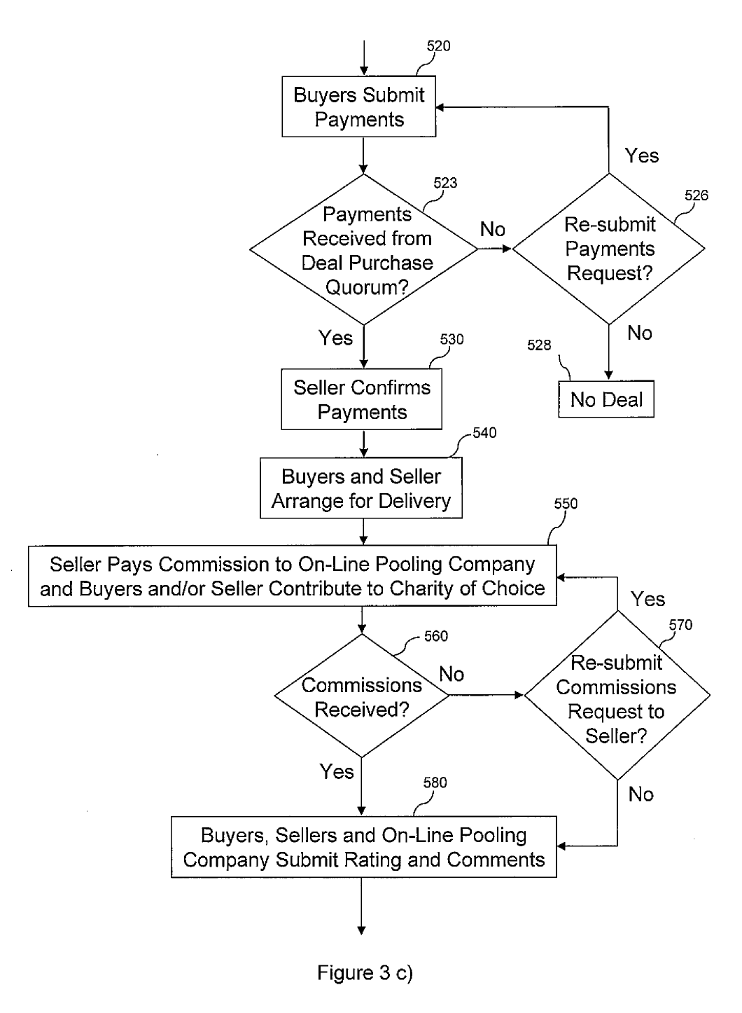

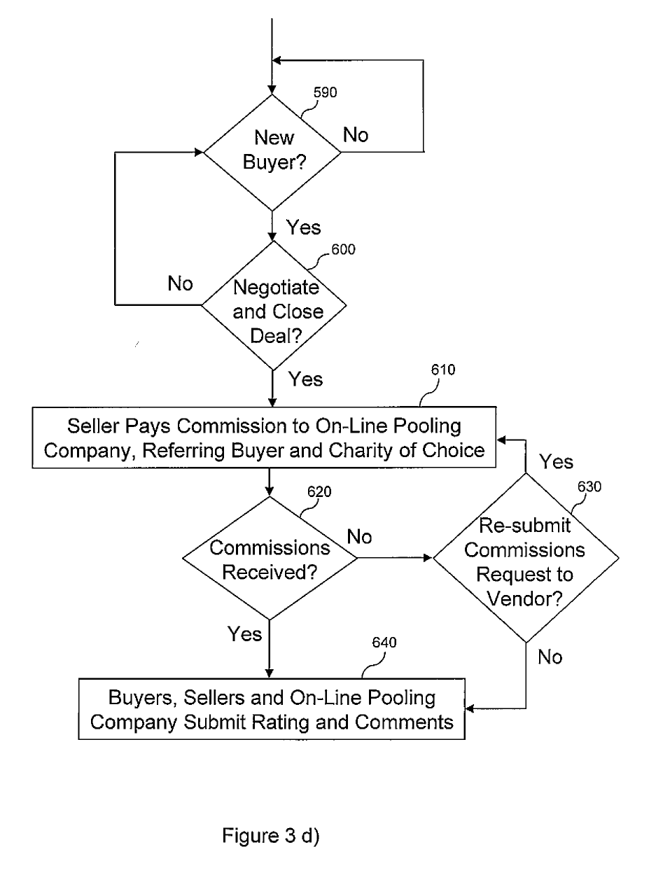

FIG. 3 a), b), c) and d) are flow diagrams illustrating the overall flow of a collaborative method that enables buyers with similar buying interests to pool themselves, approach sellers to negotiate volume discounts and favourable terms, and process deal payments. To start the process, in a similar manner to the initial steps of the Collaboration Model in FIG. 2 a), a new buyer visits html website (26) of distribution platform (28) and in step (300) decides whether to establish a new party group or review existing party groups with similar buying interests and join such preferred party group, if one exists. Should buyer decide to establish a new party group, such buyer establishes themselves as lead buyer and establishes new party group per step (310) and contacts lead seller(s) to establish interest in negotiating a volume-based for interested pool of buyers with similar buying interests per step (320). Otherwise if buyer decides to join existing party group with similar buying interests, buyer joins such group whereby existing lead buyer would engage lead seller(s) per step (320). Alternatively, per step (340), seller(s) are given the opportunity to advertise pooling based discounts for their goods and services on html website (26) of distribution platform (28). Potential buyers visit such html website and if interested in engaging with seller per step (330), such lead buyer establishes party group per step (310) and contacts lead seller(s) to establish interest in negotiating a volume-based deal for interested pool of buyers with similar buying interests per step (320).

Next, per step (350), lead buyer enters purchase criteria, required ‘deal planning’ and deal purchase' quorums, ‘deal submission’ deadline, ‘deal close’ deadline and charity of choice on html website (26) of distribution platform (28), and per step (360) buyers sign-up and send party invitation to their network of contacts via communication mechanism of such html website (26) and/or making use of other social media communication mechanisms such as facebook, twitter, rss feeds, etc. Note the deal planning and/or purchase quorum can be represented by number of buyers, cumulative deal value or any other suitable metric that may be obvious to those skilled in the art.

Other interested buyers proceed to sign-up to such party group and in a similar manner invite other possible interested buyers and sellers through their network of contacts per step (360). If the required ‘deal planning’ quorum is not reached per step (370) and the ‘deal submission’ deadline is also not reached per step (380), buyers in the party group are still given the opportunity to invite possible interested buyers through their network of contacts per step (360). If the ‘deal planning’ quorum is not reached per step (370) and the deal deadline is reached per step (380), then the deal does not proceed per step (400). Per step (370), if the ‘deal planning’ quorum is reached but the ‘deal submission deadline is not reached per step (385), buyers in the party group are again given the opportunity to invite possible interested buyers and sellers through their network of contacts per step (360). However, if the ‘deal planning’ quorum is reached per step (370) and the ‘deal submission’ deadline is reached per step (385), buyers submit their individual purchase requirements via the html website (26) of distribution platform (28) per step (390). Per step (410), html website (26) of distribution platform (28) then aggregates purchase requirements of all buyers and continuing with FIG. 3 b), forwards such aggregated purchase requirements to seller per step (420). Per step (430), seller reviews such purchase requirements and provides a quotation outlining best pricing and terms. Such quotation is returned to the buyer pool via the html website (26) of distribution platform (28) per step (440), and buyers review pricing provided in such quotation per step (450). Per step (460), if ‘deal close’ deadline is not reached, buyers continue to evaluate pricing per step (450). However, if ‘deal close’ deadline is reached per step (460), individual buyers confirm their intent to purchase per step (470). Per step (480), if ‘deal purchase’ quorum is not reached, the buyer pool is given the option of establishing a new ‘deal close’ deadline per step (490). If the ‘deal planning’ quorum established in step (350) is reached and buyers in such ‘deal planning’ quorum wish to establish a new ‘deal close’ deadline per step (490), html website (26) of distribution platform (28) forwards request and supporting information to seller to have such seller quote best pricing and terms for such new deal requirements per step (430). However, in step (490) if the ‘deal planning’ quorum established in step (350) is not reached or ‘deal purchase’ quorum in step (480) is reached, html website (26) of distribution platform (28) determines if there is another seller entered into the existing buyer pool requirements database per step (500). If another seller is available, html website (26) of distribution platform (28) forwards purchase requirements of the buyer pool to such seller per step (420). Per step (510), if no other seller is available, html website (26) of distribution platform (28) prompts buyers to close their collective best deal. Continuing with FIG. 3 c), html website (26) of distribution platform (28) enables buyers to submit individual payments to seller through 3^{rd} party payment mechanisms such as www.paypal.com per step (520). Per step (523) if all payments are not received by seller from buyers in the deal purchase quorum, the html website (26) of distribution platform (28) re-submits payments request to those buyers who have yet to make payment per step (526) and (520). When payments are received from all buyers in deal purchase quorum per step (523), seller confirms payments via html website (26) of distribution platform (28) per step (530). Otherwise, if not all buyers in the deal purchase quorum have made payment after sufficient attempts to re-submit payments request per step (526), no deal results per step (528). Once the required payments from deal purchase quorum are received and confirmed by seller per step (530), html website (26) of distribution platform (28) facilitates the interaction of buyers and seller to arrange for deliveries per step (540). Per step (550), in consideration for introducing, managing and brokering the deal transaction, seller then pays a commission to the distribution platform (28) and charity of choice established in step (350) via html website (26). Buyers are also given the opportunity to contribute to the charity of choice. It should be noted that deal terms should stipulate that once payments are made, buyers can only return purchases in exchange for future credit from seller since the required ‘deal purchase’ quorum requirement cannot be impacted. Per step (560) if seller does not pay the required commissions, the html website (26) of distribution platform (28) re-submits commissions request to seller per step (570). Otherwise if commissions are received per step (560) or after sufficient attempts to re-submit commissions request to seller per step (570), buyers, seller and distribution platform (28) are given the opportunity to rate the deal and other participants, and provide comments per step (580).

Continuing with FIG. 3 d), per step (590) after deal close, should a new buyer wish to join the party group to take advantage of discounts offered by the preferred seller with which party group completed the deal in step (510), such new buyer is allowed to join and contact seller to negotiate and close new deal per step (600). Should deal not close, new buyers are still given the opportunity to join the party group in future per step (590). However, if the new buyer successfully closes a new deal with the seller per step (600), seller pays a commission to the distribution platform (28), referring buyer and charity of choice per previously negotiated terms per step (610). Per step (620) if seller does not pay the required commissions, the html website (26) of distribution platform (28) re-submits commissions request to seller per step (630). Otherwise if commissions are received per step (620) or after sufficient attempts to re-submit commissions request to seller per step (630), buyers, seller and distribution platform (28) are given the opportunity to rate the deal and other participants, and provide comments per step (640).

Real-Time Negotiation of Financial Transaction

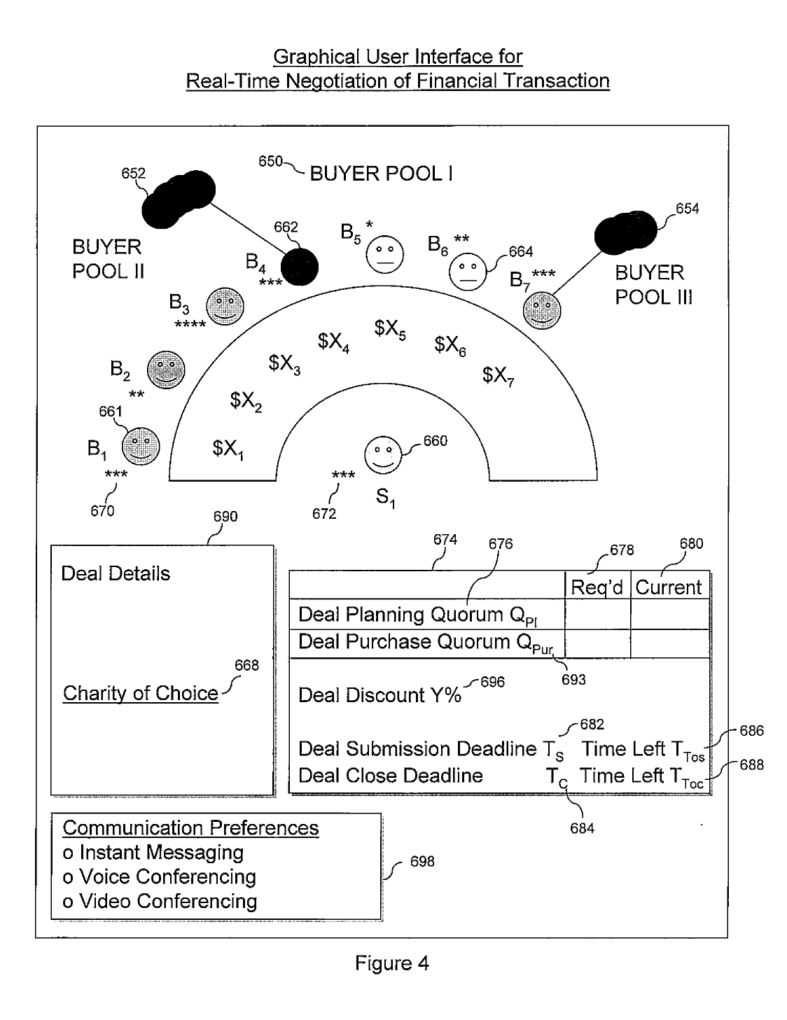

Given the challenges associated with implementing an on-line negotiation method in an asynchronous, non real-time manner in un-human like form, and to therefore facilitate the interaction of buyers and sellers in a real-time dynamic manner analogous to how deals are done in the real world, a novel graphical user interface and method is employed to effect required collaboration, negotiation and close of the required financial transaction. The established prior art has missed the opportunity to implement such an approach, thereby proving this invention is clearly non-obvious to those skilled in the art. As outlined in FIG. 4, an on-line collaboration and negotiation environment is established for a specific buyer pool, namely Buyer Pool I (650) and consisting of buyers B₁, B₂, B₃, B₄, B₅, B₆ and B₇, and seller S_{I}. In a further embodiment of the invention, the On-Line Negotiation Model method outlined above can be effectively implemented using the graphical user interface outlined in FIG. 4.

With reference to the On-Line Negotiation Model method above, the purchase criteria is entered in Deal Details (690), deal planning quorum, deal purchase quorum and applicable deal discount for such deal quorum is entered into the Req'd fields (678) as Q_{Pl} (676), as Q_{Pur} (693), and Y% (696), and deal submission deadline, deal close deadline and charity of choice details are entered as T_{S} (682), as T_{C} (668), and charity of choice (668) on FIG. 4, respectively. Time Left T_{Tos} (686) to Deal Submission Deadline T_{S} (682) and Time Left T_{Toc} (688) to Deal Close Deadline T_{C} (684) are also entered and kept updated as displayed on FIG. 4 as shown to make this information of timely importance clearly visible to the buyer pool.

As buyers sign up per step (360), the html website (26) of distribution platform (28) stores the required information in the database (24) and displays user name Bₙ respectively on FIG. 4. The facial expression is initially displayed as per icon (664) indicating neutral buying position for such buyer, and colour yellow for example can be used to emphasize such neutral position as opposed to smile icon (661) and colour green to denote deal acceptance and frown icon (662) and colour red to denote non acceptance of deal terms.

The process continues per the On-Line Negotiation Model method outlined in FIG. 3 a) and upon having reached step (390) with deal planning quorum Q_{Pl} (676) and deal submission deadline T_{S} (682) being met, such relevant information is displayed as required on FIG. 4 per fields (678) and (680), and (682) respectively. Html website (26) of distribution platform (28) also provides the option for use of various communication preferences to buyers and seller including but not limited to instant messaging, voice conferencing or video conferencing per requirements of buyers and seller as outlined in (698) on FIG. 4.

As buyers submit purchase requirements, the html website (26) of distribution platform (28) stores the required information in the database (24), aggregates purchase requirements for the buyer pool per step (410) in FIG. 3 a) forwards such purchase requirements to seller per step (420). Seller quotes best pricing and terms per step (430) and the html website (26) of distribution platform (28) returns the quotation to buyer pool per step (440) while html website (26) of distribution platform (28) dynamically updates information per updates in real-time and displays such information as required on FIG. 4. More specifically, individual buyer quotations are shown as $Xₙ (669) for n=1 to 7, and deal purchase quorum Q_{Pur}=total summation of $Xₙ is displayed and updated as required in field (680) on FIG. 4. Deal discount Y% (696) applicable to deal purchase quorum Q_{Pur} (693) is also displayed and updated in real-time on FIG. 4 with Time Left T_{Toc} (688) to deal close deadline also counted down in real-time and displayed accordingly on FIG. 4. Buyers evaluate pricing per step (450) on FIG. 3 b) and upon deal close deadline being reached per step (460) and Time Left T_{Toc} (688) having expired per FIG. 4, buyers confirm purchase requirements per step (470) on FIG. 3 b) and buyer status is dynamically updated and graphically displayed on FIG. 4. If the deal purchase quorum is not reached per step (480) on FIG. 3 b), and new deal closed deadline can be established per step (490), Time Left T_{Toc} (688) on FIG. 4 is updated accordingly and method continues with step (430) on FIG. 3 b). However, if deal purchase quorum is reached per step (480) or new deal close deadline is not established per step (490) on FIG. 3 b), if another seller is waiting to provide a quotation to the buyer pool per step (500) on FIG. 3 b), the method continues with step (420) applicable to new seller and html website (26) of distribution platform (28) archives quotation information from deal with first seller in database (24) and dynamically updates information on FIG. 4 to reflect new deal requirements for buyer pool and next seller. The process continues until such time as there are no other sellers, at which point buyer pool closes best deal with respective seller per step (510) on FIG. 3 b). The process per FIGS. 3 c) and d) continues as outlined in the On-Line Negotiation Model method above. It should be noted that ratings provided in steps (580) and (640) are stored by html website (26) of distribution platform (28) in database (24) and ratings for buyers and sellers are visually displayed per rating symbols (670) and (672) on FIG. 4, along with stored comments that can be displayed on screen by moving cursor over and/or clicking on rating symbols (670) and/or (672). Such rating results can also be displayed as required by html website (26) of distribution platform (28).

The graphical user interface for real-time negotiation of financial transaction also provides the capability for having buyer pool I (650) collaborate with buyer pool II (652), buyer pool III (654), and effectively buyer pool N for N=2 and greater, to further leverage their collective buying power.

Location-Based Model

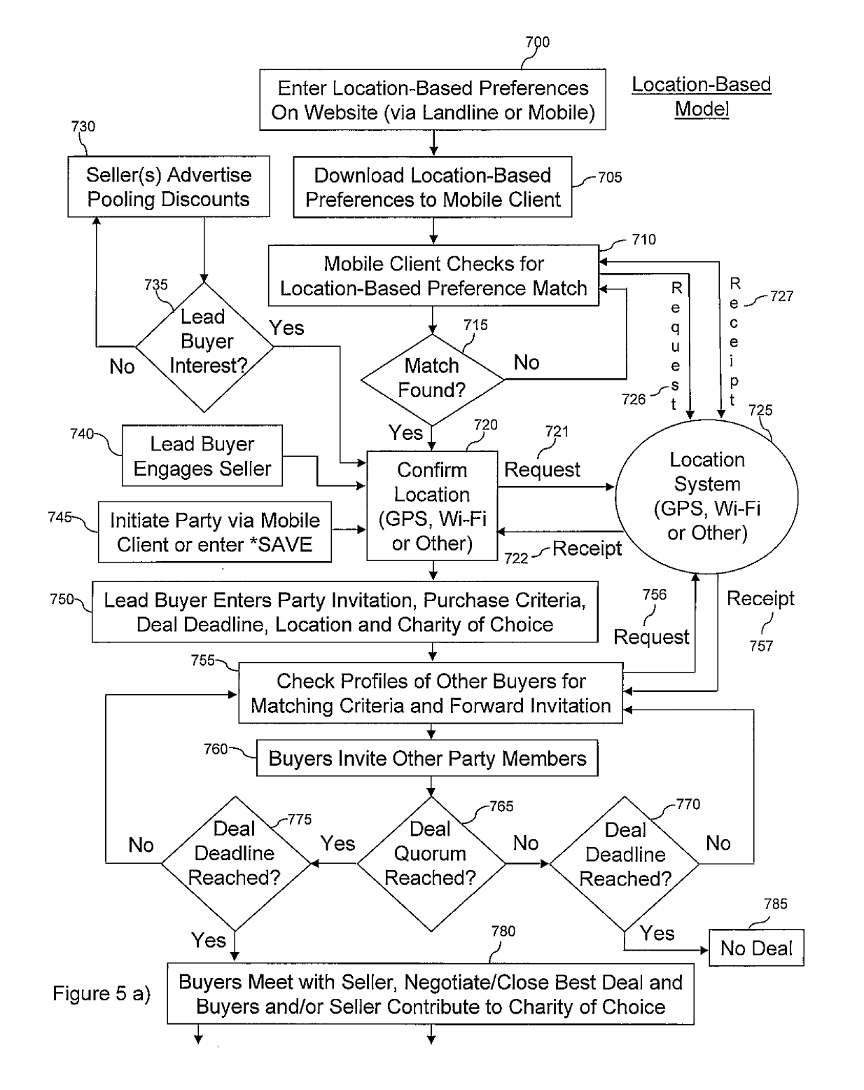

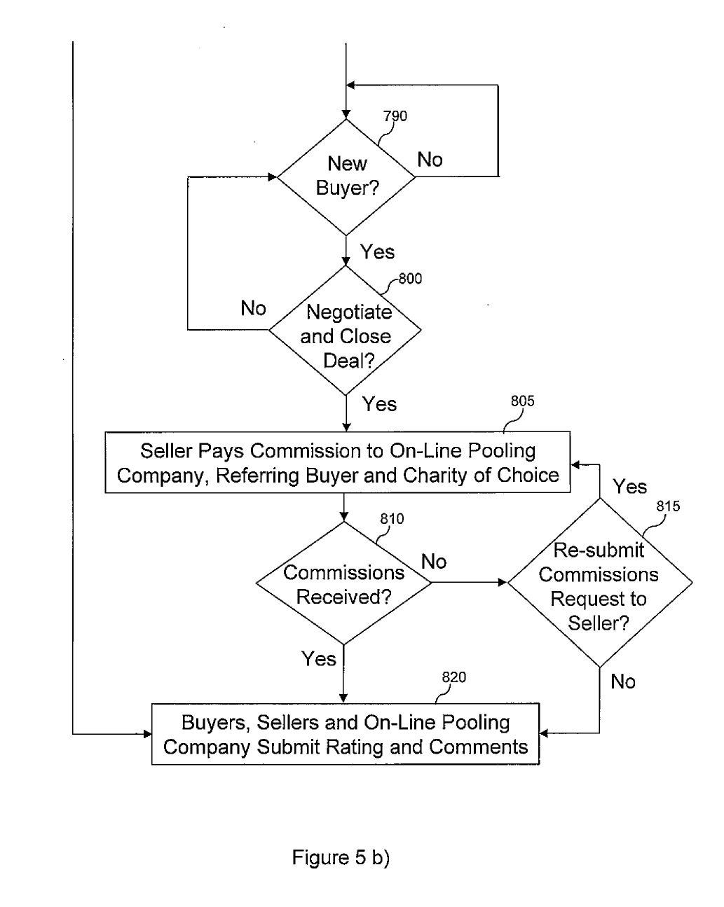

In a further embodiment of the invention, given the need to enable buyers to pool themselves and collaborate with sellers in a spontaneous and dynamic manner without the need to set-up a pre-planned purchase, a location-based model method is outlined in FIGS. 5 a) and b). For example, given the freedom of mobility and associated benefits of instant communication and location-based capabilities enabled through mobile phones and personal digital assistants with wireless (cellular, Wi-Fi and/or other) and Global Positioning Satellite (GPS) and/or other location-based capabilities, the location-based model method can be used by buyers who would like to be alerted of other buyers with similar purchase interests who may also simultaneously be in the vicinity of the local department store, automotive showroom or fashion outlet at the same time. The dynamic pooled financial transaction capabilities of the invention allow for such users to identify themselves, explore and confirm similar buying interests, and approach sellers that may be interested in offering discounts for such financial transactions through use of voice, data and location-based capabilities. The prior art does not make use of such capabilities to effect such dynamic pooled financial transactions and as a result, the invention's location-based model capabilities are non-obvious to those skilled in the art.

More specifically, buyers are given the opportunity to enter location-based preferences via their landline internet connection or mobile device, per step (700), outlining information such as purchase interests, preferred supplier(s), geographic location, preferred timing for buyer pool collaboration and/or permission criteria to notify such buyer of buyer pool opportunity when the appropriate criteria are satisfied, and have such buyer-specific information, activity history, etc. tracked by distribution platform (28). Per step (705), if these preferences are established via landline internet connection, such preferences are downloaded to buyer's mobile client version of html website (26) of distribution platform (28). Otherwise if such preferences are entered using mobile device, such preferences are updated to same mobile client version. Per step (710), the mobile client application checks for a location-based or other preference match, for example, if buyer roams into a preferred geographic area and is willing to initiate a buyer pool with other interested buyers at this time, the mobile client interfaces with html website (26) of distribution platform (28) to check with other mobile clients that match the same preference criteria. To check for a location-based preference match, the mobile client sends a request (726) to a location identification system (725) to confirm mobile device location. Such location identification system (725) then returns the required information to the mobile client via receipt (727). If no match is found per step (715), the mobile client continues to check for a location-based preference match. If per step (715) a match is found, per step (720) the mobile client sends a request (721) to a location identification system (725) to confirm mobile device location. Such location identification system (725) then returns the requested information to the mobile client via receipt (722).

A number of other triggers can also be used to initiate a location-based buyer pool including but not limited to the following: per step (730), sellers can advertise volume-based pooling discounts and these can be made available via html website (26) of distribution platform (28), mobile version of such client and/or notification to buyers who have indicated a preference to receive such notifications. Per step (735), if there is lead buyer interest, the method continues with step (720) and onwards. Per step (740), a lead buyer may engage seller by walking into their place of business for example, and the method continues with step (720) and onwards. Per step (745), a buyer may also initiate a buyer pool party via their mobile client or for text-limited mobile devices, such party can be initiated by entering an appropriate text-based code such as #SAVE for example and in this case, the method would continue with a text-based version of mobile client from step (720) and onwards.

When the required location identification information is received from location identification system (725) per step (720), lead buyer enters party invitation, purchase criteria, required deal quorum, deal deadline, location and charity of choice per step (750). Per step (755), the mobile client interfaces with html website (26) of distribution platform (28) to check profiles of other buyers for matching purchase criteria, timing, location, etc., interfaces with location identification system (725) to verify location of buyers matching other criteria by sending request (756) to such location identification system and receiving the required information via receipt (757). Mobile client then forwards buyer pool party invitation to buyers that match such required criteria. Continuing with step (760), buyers sign-up and send party invitation to their network of contacts via communication mechanism of mobile client of html website (26) and/or making use of other social media communication mechanisms such as facebook, twitter, rss feeds, etc. Other interested buyers proceed to sign-up to such party group and in a similar manner invite other possible interested buyers through their network of contacts per step (760). If the required deal quorum is not reached per step (765) and the deal deadline is also not reached per step (770), buyers in the party group are still given the opportunity to invite possible interested buyers and sellers through their network of contacts per step (760). If the deal quorum is not reached per step (765) and the deal deadline is reached per step (770), then the deal does not proceed per step (785). Per step (765), if the deal quorum is reached but the deal deadline is not reached per step (775), buyers in the party group are again given the opportunity to invite possible interested buyers through their network of contacts per step (760). However, if the deal quorum is reached per step (765) and the deal deadline is reached per step (775), buyers arrange to meet with seller in person at a mutually convenient time in the near future given their location-based proximity to one another to review their requirements and negotiate their best deal per step (780). With this collaboration model, the mobile client of html website (26) of distribution platform (28) enables communication of buyers and sellers through exchange of their contact information via their preferred communication mechanism(s) including but not limited to a meeting location at geographic address, conference calling using traditional telephony, VoIP, e-mail, text messaging, social networking media and/or other means.

Upon completion of negotiation of best deal terms per step (780), buyers in the party group close their best deal with seller and contribute a portion of the savings earned to their charity of choice. Using this Collaboration Model method, all payment transactions are carried out between buyers and seller on a person-to-person basis using cash, credit and/other established payment methods. Continuing with FIG. 5 b), buyers, seller and distribution platform (28) are given the opportunity to rate the deal and other participants, and provide comments per step (820). Per step (790) after deal close, should a new buyer wish to join the party group to take advantage of discounts offered by the preferred seller with which party group completed the deal in step (780), such new buyer is allowed to join and contact seller to negotiate and close new deal per step (800). Should deal not close, new buyers are still given the opportunity to join the party group in future per step (790). However, if the new buyer successfully closes a new deal with the seller per step (800), seller pays a commission to the distribution platform (28), referring buyer and charity of choice per previously negotiated terms per step (805). Per step (810) if seller does not pay the required commissions, the html website (26) of distribution platform (28) re-submits commissions request to seller per step (815). Otherwise if commissions are received per step (810) or after sufficient attempts to re-submit commissions request to seller per step (815), buyers, seller and distribution platform (28) are given the opportunity to rate the deal and other participants, and provide comments per step (820).

Summary

Although the above descriptions contain many details and specifics, these should not be construed as limiting the scope of the invention in any manner but merely as outlining the embodiments preferred at the present time, since many embodiments are possible. For example, the reason for the buyer pool being established need not necessarily be to purchase goods but can also relate to a common cause or purpose whereby persons of the same mindset with similar collective goals can pool together to then approach parties who are causing them concern in order to explore common ground and negotiate a preferred settlement.

In addition, the collaboration involved with the pooling methods described need not be conducted over the internet using a world wide web server. The methods are just as effective using any communication network or combination of networks to allow the communication of data and/or text, voice, video, etc. between buyers and sellers.

Therefore, the scope of the invention is not limited to the examples described, but encompasses all methods within the scope of the following claims in order to explain the principles of the invention and its practical applications to therefore enable others skilled in the art to utilize the invention for the specific use contemplated.

I claim:

1. A computer network implemented sales method for organizing and completing a dynamic pooled transaction involving at least two buyers and at least one seller, wherein the at least two buyers and at least one seller are each associated with a network-connected communication device, such method comprising the following steps:
enabling a group of buyers including at least two buyers, by operation of a server computer that implements a distribution platform for organizing and completing a dynamic pooled transaction, wherein the server computer communicates with the network-connected communication devices via a wired or wireless communication network, to explore dynamically similar purchase criteria for establishing a buying pool, for approaching at least one seller with a solicitation for the purchase of goods or services;
enabling the group of buyers to invite their contacts to join the buying pool, and communicating one or more data elements associated with the buying pool to other interested buyers associated with the server computer and enabling such other buyers interested in joining the buyer pool to join such buyer pool;
if similar purchase criteria for such buyer pool are satisfied within the required time constraint, enabling the buyer members to connect with the at least one seller to negotiate a quotation for pooled goods or services requirements of such buyer pool; if one or more other sellers is also available to provide a quotation, enabling such buyer pool members to further connect with such one or more other sellers until quotations from all sellers have been obtained and/or buyer pool closes one or more transactions based on the goods or services;
enabling the group of buyers, and optionally one or more sellers by operation of the server computer to submit rating and comments;
enabling the group of buyers to establish consensus by operation of the server computer around a quotation of a particular seller, or winning seller; and
if a consensus is established within the group of buyers, enabling the group of buyers having reached such consensus to close the one or more transactions based on the goods or services with the winning seller.

2. The method of claim 1, wherein if a new buyer is interested in participating in the one or more transactions, enabling such new buyer to approach the winning seller to negotiate and close best deal; such seller pays commission to distribution platform and referring buyer;
when commissions received, buyers, seller and distribution platform submit rating and comments, otherwise re-submit commissions request to seller until such time that commissions request is exhausted at which time buyers, seller and distribution platform submit rating and comments.

3. The method of claim 1, wherein sellers can advertise discounts for buyers with similar purchase criteria who are willing to establish buyer pools.

4. The method of claim 1, wherein similar purchase criteria comprises goods and/or services available from a specific seller.

5. The method of claim 1, wherein similar purchase criteria comprises a quorum of buyers for deal implementation.

6. The method of claim 1, wherein similar purchase criteria comprises a time constraint.

7. The method of claim 1, wherein similar purchase criteria comprises a charity of choice.

8. The method of claim 1, further comprising the step of establishing a quorum of buyers for deal planning within similar purchase criteria.

9. The method of claim 1, wherein
when quorum of buyers for deal planning and time constraint is reached, buyers submit purchase requirements via a website;
the server computer aggregates purchase requirements and forwards purchase requirements to seller, seller quotes best pricing and terms;
the server computer returns quotation to buyer pool and buyers evaluate pricing;
if a deal close deadline is reached buyers confirm the one or more transactions but if deal purchase quorum is not reached, the server computer establishes a new deal close deadline and the one or more sellers are given an opportunity to quote again and this repeats until a quorum for closing the one or more transactions is reached;
if one or more other sellers are available to provide quotation, the server computer forwards purchase requirements to the one or more other sellers and this repeats until the buyer pool closes the one or more transactions with the winning seller;
optionally the buyers submit payments, the seller confirms payments, and the buyers and the seller arrange for delivery; and
the seller pays a commission to the operator of the server computer.

10. The method of claim 1, wherein
after deal close, if new buyer wishes to join the party group to take advantage of discounts offered by the preferred seller with which said party group completed the prior deal, such new buyer is allowed to join and contact seller to negotiate and close new deal;
should deal not close, new buyers are still given the opportunity to join the party group;
if the new buyer successfully closes a new deal with the seller, seller pays a commission to the distribution platform and referring buyer per previously negotiated terms;
if seller does not pay the required commissions, the computer server re-submits commissions request to seller;
otherwise if commissions are received or after sufficient attempts to re-submit commissions request to seller, buyers, seller and distribution platform rate the deal and other participants, and provide comments.

11. The method of claim 1, wherein buyers and/or sellers contribute a portion of proceeds to charity of choice.

12. The method of claim 1, further comprising a graphical user interface for real-time negotiation of financial transaction between buyer pool and sellers.

13. The method of claim 1, further comprising the step:
buyers entering location-based preferences via their landline internet connection or mobile device, outlining information such as purchase interests, geographic location, preferred timing for buyer pool collaboration and/or permission criteria to notify such buyer of buyer pool opportunity when such criteria are satisfied;
if these preferences are established via landline internet connection, such preferences are downloaded to buyer's mobile client or otherwise if such preferences are entered using mobile device, such preferences are updated to same mobile client;
mobile client checks for a location-based preference match and said mobile client interfaces with computer server to cheek with other mobile clients that match the same preference criteria, and if no match is found, the mobile client continues to check for a location-based preference match;
if a match is found, the mobile client sends a request to a location identification system to confirm mobile device location. Said location identification system then returns the requested information to the mobile client via receipt;
when the required location identification information is received from location identification system, lead buyer enters party invitation, purchase criteria, required quorum of buyers for deal implementation, time constraint, location and charity of choice;
mobile client interfaces with computer server to check profiles of other buyers for matching purchase criteria, timing, location, etc., and interfaces with location identification system to verify location of buyers matching other criteria and forwards buyer pool party invitation to buyers that match such required criteria;
buyers sign-up and send party invitation to their network of contacts via communication mechanism of mobile client of computer server and/or making use of other social media communication mechanisms such as facebook, twitter, rss feeds, etc.;
other interested buyers proceed to sign-up to such party group and in a similar manner invite other possible interested buyers through their network of contacts;
if the required deal quorum of buyers is not reached and the deal deadline is also not reached, buyers in the party group are still given the opportunity to invite possible interested buyers and sellers through their network of contacts. If the deal quorum is not reached and the deal deadline is reached, then the deal does not proceed. If the deal quorum is reached but the deal deadline is not reached per step, buyers in the party group are again given the opportunity to invite possible interested buyers through their network of contacts;
if the required deal quorum of buyers is reached and the time constraint is reached, buyers arrange to meet with seller in person at a mutually convenient time in the near future given their location-based proximity to one another to review their requirements and negotiate their best deal;
the mobile client of computer server enables communication of buyers and sellers through exchange of their contact information via their preferred communication mechanism(s) including but not limited to a meeting location at geographic address, conference calling using traditional telephony, VoIP, e-mail, text messaging, social networking media and/or other means;
upon completion of negotiation of best deal terms per step, buyers in the party group close their best deal with seller, and sellers and/or buyers contribute a portion of the savings earned to their charity of choice;
payment transactions are carried out between buyers and seller on a person-to-person basis using cash, credit and/other established payment methods but other methods of payment which become obvious to those skilled in the art can also be effectively employed;
buyers, seller and distribution platform are given the opportunity to rate the deal and other participants, and provide comments.

14. The method of claim 1, wherein a number of other triggers can also be used to initiate a location-based buyer pool including but not limited to the following:
sellers can advertise pooling discounts and these can be made available via the computer server to mobile version of such client and/or notification to buyers who have indicated a preference to receive such notifications;
a lead buyer may engage seller by walking into their place of business;
a buyer may initiate a buyer pool party via their mobile client;
for text-limited mobile devices, such party can be initiated by entering an appropriate text-based code such as #SAVE for example and in such case, the method would continue with a text-based version of mobile client.

15. The method of claim 1 wherein a franchising model and method is implemented for white labeling bricks-and-mortar pooling depots to facilitate volume deliveries for buyers from manufacturers and OEMs, thereby allowing buyer pools of sufficient critical mass to deal directly with such manufacturers and OEMs, and disrupting the established manufacturer/distributor/sales outlet business model and further increasing the value to buyers through the reduction of price of goods and deal facilitation. The pooling depot would receive a commission from sellers and/or buyers for its role and value-add in facilitating deals and/or deliveries.
